(19) United States
(12) Patent Application Publication
(10) Pub. No.: US 2012/0084368 A1
(43) Pub. Date: Apr. 5, 2012

(54) DATA CHANNEL SET UP LATENCY REDUCTION

(75) Inventors: Sunning Chun Ning Go, Waterloo (CA); Allan David Lewis, Waterloo (CA); Bruno Richard Preiss, Waterloo (CA)

(73) Assignee: RESEARCH IN MOTION LIMITED, Waterloo (CA)

(21) Appl. No.: 12/897,991

(22) Filed: Oct. 5, 2010

(51) Int. Cl. G06F 15/16; H04L 9/32

(52) U.S. Cl. 709/206; 713/171

(57) ABSTRACT

A method is disclosed for reducing setup latency in commencing data exchange between two devices seeking to exchange data across a networked data channel. Control messages are exchanged across a control channel while establishing the data channel according to a protocol. The control messages contain some of the data to be exchanged. The remaining data is exchanged across the data channel once established. The data both in the control messages and exchanged across the data channel may be tagged with a file transfer identifier to facilitate reconstruction of the data at the receive end. If data encryption is desired, the data in the control messages may be encrypted by the sender with a temporary key and a shared key may be established by the devices. Once the key has been established, the temporary key may be encrypted with the shared key and exchanged across the data channel to permit decryption of the data in the control messages at the receive end.

### RELATED DISCLOSURES

Not Applicable.

### INTRODUCTION

In many communications systems, when two devices wish to communicate with one another, a data channel is set up between them for such a purpose. Typically, there may be a considerable latency in establishing the data channel, which may inhibit communications.

This latency may manifest itself in the exchange of control messages along a control channel in accordance with a recognized communications protocol. Such latency may also arise from the exchange of control messages to establish higher level communications schemes along such a data channel, for example, to establish a secure communications link along the data channel.

Such latencies may be increased significantly where one or both of the devices is a mobile device.

### DRAWINGS

The embodiments of the present disclosure will now be described by reference to the following figures, in which identical reference numerals in different figures indicate identical elements and in which:

FIG. 1 is a block diagram illustrating the establishment of a data channel between a first device and a second device according to an example embodiment of the present disclosure;

FIG. 2A is a block diagram showing example messages exchanged by the components of FIG. 1 to establish a data channel by hole punching;

FIG. 2B is a table showing the format and contents of each of the example messages shown in FIG. 2A;

FIG. 3A is a block diagram showing example messages exchanged by the components of FIG. 1 to establish a data channel by hole punching with reduced set up latency according to example embodiments;

FIG. 3B is a table showing the format and contents of each of the example messages shown in FIG. 3A;

FIG. 4 is a flow chart showing example processing actions by one of the devices of FIG. 1 to reduce setup latency while establishing the data channel according to an embodiment of the present disclosure;

FIG. 5A is a block diagram showing example messages exchanged by the components of FIG. 1 to establish an encrypted data channel by hole punching followed by Diffie-Hellman key exchange;

FIG. 5B is a table showing the format and contents of each of the example messages shown in FIG. 5A;

FIG. 6A is a block diagram showing example messages exchanged by the components of FIG. 1 to establish an encrypted data channel by hole punching and Diffie-Hellman key exchange with reduced set up latency according to the example embodiments;

FIG. 6B is a table showing the format and contents of each of the example messages shown in FIG. 6A;

FIG. 7 is a flow chart showing example processing actions by one of the devices of FIG. 1 to reduce set up latency while establishing the data channel and determining a shared encryption key for the data channel according to an embodiment of the present disclosure;

FIG. 8 is a graphical representation of a front view of an example mobile device for use in the example embodiment of FIG. 1; and

FIG. 9 is a simplified block diagram of the example device of FIG. 8.

### DESCRIPTION

The present disclosure will now be described in detail for the purposes of illustration only, in conjunction with certain embodiments shown in the enclosed drawings. A device capable of acting as the first or second device and implementing this method is also disclosed. According to various example embodiments, methods and devices are disclosed for reducing set up latency when establishing a data channel between two devices.

According to a first example embodiment there is disclosed a method for sending data from a first device to a second device over a network, comprising at the first device sending at least one control message to the second device along a control channel prior to establishing a data channel between the first device and the second device; including some data from a data source in the at least one control message prior to establishing the data channel; and sending remaining data from the data source to the second device along the data channel once the data channel has been established.

In one example embodiment, the method may provide for encrypting the data included in the at least one control message with a temporary key; encrypting key information identifying the temporary key with a further key known only to the first device and second device; and sending the encrypted key information to the second device along the data channel, once the data channel has been established, for decrypting the data included in the at least one control message at the second device.

According to a second example embodiment there is disclosed a first device for sending data to a second device over a network, the first device for: sending at least one control message to the second device along a control channel prior to establishing a data channel between the first device and the second device; including some data from a data source in the at least one control message prior to establishing the data channel; and sending remaining data from the data source to the second device along the data channel once the data channel has been established.

In one example embodiment, the first device may provide for encrypting the data included in the at least one control message with a temporary key; encrypting key information identifying the temporary key with a further key known only to the first device and second device; and sending the encrypted key information to the second device along the data channel, once the data channel has been established, for decrypting the data included in the at least one control message at the second device.

According to a third example embodiment there is disclosed a computer-readable medium in a first device for sending data to a second device over a network, the medium having stored thereon, computer-readable and computer-executable instructions which, when executed by a processor, cause the processor to perform actions comprising: sending at least one control message to the second device along a control channel prior to establishing a data channel between the first device and the second device; including some data from a data source in the at least one control message sent prior to establishing the data channel; and sending remaining data from the data source to the second device along the data channel once the data channel has been established.

In one example embodiment, the computer-readable medium may cause the processor to perform acts comprising: encrypting the data included in the at least one control message with a temporary key; encrypting key information identifying the temporary key with a further key known only to the first device and second device; and sending the encrypted key information to the second device along the data channel, once the data channel has been established, for decrypting the data included in the at least one control message at the second device.

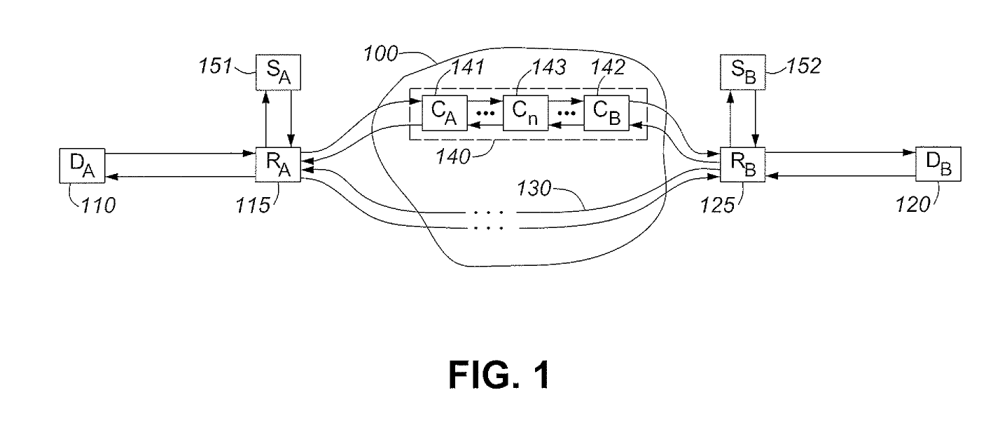

Turning now to FIG. 1, there is shown a conceptual representation of an example scenario in which a first mobile device D_{A} 110 and a second device D_{B} 120 seek to establish a data channel within a network shown generally at 100, for the exchange of one or more data packets, which may be associated with a data source, such as a data file or a real-time data source.

In the example embodiment of FIG. 1, network 100 comprises a plurality of devices D_{A} 110 D_{B} 120, routers R_{A} 115, R_{B} 125, one or more Simple Traversal of User Datagram Protocol (UDP) through NATs (STUN) servers S_{A} 151, S_{B} 152, a control channel 140 encompassing one or more control servers 141-143 and a data channel 130 extending between each device D_{A} 110, D_{B} 120. As shown in the non-limiting example of FIG. 1, router R_{A} 115, control server C_{A} 141 and STUN server S_{A} 151 are associated with device D_{A} 110, while router R_{B} 125, control server C_{B} 142 and STUN server S_{B} 152 are associated with device D_{B} 120.

### Devices

In at least some example embodiments, device D_{A} 110 is a mobile communications device that may have a two-way electronic messaging communications capability and possibly also a voice communication capability. Depending on the functionality provided by the device D_{A} 110, in various embodiments, device D_{A} 110 may be a wireless handset, a data communications device, a multiple-mode communications device configured for both data and voice communication, a mobile telephone, a pager, a personal digital assistant (PDA), which may be enabled for wireless communications, a personal entertainment device, a telecommunications device installed within a vehicle, a portable, laptop, notebook or tablet computer with a wireless modem or wireless network card, or a portable, laptop, notebook or tablet computer or a phone device with a fixed connection to a network, among other things. Many suitable devices may combine some or all of these functions. The device D_{A} 110 may support specialized activities, such as gaming, inventory control, job control and task management functions and the like.

The device D_{A} 110 may include a controller that includes at least one processor (not shown) or digital signal processor (not shown) or both for controlling the overall operation of the device D_{A} 110. The processor/DSP may interact with a communications subsystem (not shown) so as to give effect to the processing and exchange of messages described herein.

Device D_{A} 120 may be a computer, including for example, a server, a personal computer or a second mobile device such as described above, among other things.

Device D_{A} 110, sends messages to router R_{A} 115 and receives messages from router R_{A} 115 and device D_{B} 120 sends messages to router R_{B} 125 and receives messages from router R_{B} 125.

### Routers

The router R_{A} 115 and router R_{B} 125 are network address translation (NAT) devices that modify network address information in data packet headers. NAT devices or routers use translation tables to map addresses, such as private network addresses associated with a device behind the router, into a single IP address in a public address space, and rewrites an outgoing Internet Protocol (IP) address so that the address appears to originate from the router at the public address, building suitable translation tables in the process. Messages incoming from the network intended for the device behind the router are translated using the translation tables back into the originating IP address in the private network address space. NAT within the router thus obscures an internal network's structure and all traffic appears to outside parties as if the traffic originates from the router.

Because the router builds up the translation tables in the process of processing an outbound data packet (that is from the device behind the router to an address in the public address space serviced by the network), outbound messages should precede inbound messages. For security reasons, a router may keep track, in a translation table, of which external devices the device behind the router has sent packets to and will drop any received unsolicited packets, that is, packets received from an external device to which no packets have been previously sent by the device by the router. However, with the prevalence of NAT in modern computer networks, it is increasingly likely that both devices that wish to communicate with one another will be hidden behind a respective router.

Various techniques exist to establish communications between devices that are hidden behind respective routers. For example, both devices may establish a connection with one or more third-party servers that are unencumbered by routers, thus forming a control channel over the network that is immediately accessible. Control messages may be exchanged along the control channel 140 to establish, in accordance with a recognized communications protocol, a direct data channel, consisting of zero, one or more nodes in a communications network interposed between the routers associated with each device, along which messages may be exchanged between the devices.

Router R_{A} 115, among other things, may (a) forward STUN messages (described below) to STUN server S_{A} 151 and receive STUN messages from STUN server S_{A} 151, (b) forward control messages to control server C_{A} 141 for transmission along the control channel 140 to device D_{B} 120 (through router R_{B} 125) and may receive control messages along the control channel 140 from control server C_{A} 141 that emanate from device D_{B} 120 (through router R_{B} 125), (c) forward data messages to router R_{B} 125 along the data channel 130 (when established), for forwarding to device D_{B} 120 and receive data messages from device D_{B} 120 (through router R_{B} 125) along the data channel 130 (when established), and (d) forward messages to device D_{A} 110 and receive messages from device D_{A} 110.

Messages received by router R_{A} 115 from device D_{A} 110 and intended for a node or device along the network 100 will contain public coordinates (a′, p′) and private coordinates (a, p) in their respective destination and source message header fields, where, by way of non-limiting example, each set of coordinates comprises a data pair of an IP address a and a port number p. Router R_{A} 115 replaces the private coordinates (a, p) associated with device D_{A} 110 with public coordinates (a′, p′) in the source message header field as part of the network address translation activity performed by router R_{A} 115 and keeps track of the public coordinates assigned. Additionally, router R_{A} 115 may maintain a list of public coordinates (a′, p′) contained in the destination message header field of messages received from device D_{A} 110 in a translation table so as to permit the transmission, back to device D_{A} 110, of messages having such coordinates as the source message header field.

Messages received by R_{A} 115 from a node or device along the network 100 whose source message header field is on the translation table of router R_{A} 115 will be forwarded by router R_{A} 115 to device D_{A} 110, but with the public coordinates (a′, p′) replaced by the private coordinates (a, p) associated with device D_{A} 110 in the destination message header field.

Router R_{B} 125 may, among other things: (a) forward STUN messages to STUN server S_{B} 152 and receive STUN messages from STUN server S_{B} 152, (b) forward control messages to control server C_{B} 142 for transmission along the control channel 140 to device D_{A} 110 (through router R_{A} 115) and may receive control messages along the control channel 140 from control server C_{B} 142 that emanate from device D_{A} 110 (through router R_{A} 115), (c) forward data messages to router R_{A} 115 along the data channel 130 (when established) for forwarding to device D_{A} 110 and receive data messages from device D_{A} 110 (through router R_{A} 115) along the data channel 130 (when established), and (d) forward messages to device D_{B} 120 and receive messages from device D_{B} 120.

Messages received by router R_{B} 125 from device D_{B} 120 and intended for a node or device along the network 100 will contain public coordinates (a′, p′) and private coordinates (a, p) in their respective destination and source message header fields. Router R_{B} 125 replaces the private coordinates (a, p) associated with device D_{B} 120 with public coordinates (a′, p′) in the source message header field as part of the network address translation activity performed by router R_{B} 125 and keeps track of the public coordinates assigned. Additionally, router R_{B} 125 may maintain a list of public coordinates (a′, p′) contained in the destination message header field of messages received from device D_{B} 120 in a translation table so as to permit the transmission back to device D_{B} 120 of messages having such coordinates as the source message header field.

Messages received from a node or device along the network 100 whose source message header fields are on the translation table of router R_{B} 125 will be forwarded by router R_{B} 125 to device D_{B} 120, but with the public coordinates (a′, p′) replaced by the private coordinates (a, p) associated with device D_{B} 120 in the destination message header field.

### STUN Servers

STUN servers S_{A} 151, S_{B} 152 receive and return STUN messages to their associated devices D_{A} 110, D_{B} 120, by which an associated device D_{A} 110, D_{B} 120 and their associated routers R_{A} 115, R_{B} 125, may learn what are the public network coordinates assigned to the device D_{A} 110, D_{B} 120, by their associated routers R_{A} 115, R_{B} 125. Although illustrated as separate nodes, STUN server S_{A} 151 and S_{B} 152 may be the same node.

STUN server S_{A} 151 may receive STUN messages from router R_{A} 115 and may return STUN messages to router R_{A} 115. The STUN message received from router R_{A} 115 may be a STUN request message initiated by device D_{A} 110 and the response may be a STUN response message containing, as part of its payload, the public coordinates (a′, p′) assigned by router R_{A} 115 to device D_{A} 110. The public coordinates of STUN server S_{A} 151 are added to the translation table of router R_{A} 115 when the router R_{A} 115 receives the STUN request message initiated by device D_{A} 110. When a STUN response message is forwarded back to device D_{A} 110 by router R_{A} 115, even though the public coordinates will have been replaced by the private coordinates corresponding to device D_{A} 110 in the STUN response message header field, the public coordinates maintained in the STUN response message payload will remain intact.

Similarly, STUN server S_{B} 152 may receive STUN messages from router R_{B} 125 and may return STUN messages to router R_{B} 125. The STUN message received from router R_{B} 125 may be a STUN request message initiated by device D_{B} 120 and the response may be a STUN response message containing, as part of its payload, the public coordinates (a′, p′) assigned by router R_{B} 125 to device D_{B} 120. The public coordinates of STUN server S_{B} 152 are added to the translation table of router R_{B} 125 when the router R_{B} 125 receives the STUN request message initiated by device D_{B} 120. When a STUN response message is forwarded back to device D_{B} 120 by router R_{B} 125, even though the public coordinates will have been replaced by the private coordinates corresponding to device D_{B} 120 in the STUN response message header field, the public coordinates maintained in the STUN response message payload will remain intact. It will be appreciated that devices D_{A} 110 and D_{B} 120 may share a common STUN server 151, 152.

Control Channel/Control Servers

Control server C_{A} 141 associated with device D_{A} 110 may receive control messages from device D_{A} 110 (forwarded by router R_{A} 115) and transmit them (via intermediate control server(s) 143 as appropriate) through control server C_{B} 142 associated with device D_{B} 120 to router R_{B} 125 for forwarding to device D_{B} 120 and may receive control messages (via intermediate control server(s) 143 as appropriate) from device D_{B} 120 (forwarded by router R_{B} 125) through control server C_{B} 142 associated with device D_{B} 120 and transmit them to device D_{A} 110 (through router R_{A} 151).

Control server C_{B} 142 associated with router R_{B} 125 may receive control messages from device D_{B} 120 (forwarded by router R_{B} 125) and transmit them (via intermediate control server(s) 143 as appropriate) through control server C_{A} 141 associated with device D_{A} 110 (forwarded by router R_{A} 115) to router R_{A} 115 for forwarding to device D_{A} 110 and may receive control messages (via intermediate control server(s) 143 as appropriate) from device D_{A} 110 (forwarded by router R_{A} 115) through control server C_{A} 141 associated with device D_{A} 110 and transmit them to device D_{B} 120 (through router R_{B} 125).

Although illustrated as separate nodes, in some example embodiments, control servers C_{A} 141 and C_{B} 142 may be the same node, in which case the control channel 140 consists simply of such control server.

In a steady state scenario, such as described herein, the device D_{A} 110 will have previously made an outbound connection (not shown) through router R_{A} 115 to control server 141 associated with the device D_{A} 110 and the device D_{B} 120 will have previously made an outbound connection (not shown) through router R_{B} 125 to control server 142 associated with the device D_{B} 120 so that there is no NAT traversal issue. Thus, messages may be freely exchanged by devices D_{A} 110 and D_{B} 120, as shown, through their respective routers R_{A} 115, R_{B} 125 along the control channel 140.

When the control channel 140 has been established, a control message from device D_{A} 110 through router R_{A} 115 and intended for device D_{B} 120, will have its destination message header field populated with the public coordinates of control server C_{A} 141 and its payload will indicate that the intended destination device is device D_{B} 120. Each control server 141-143 in the path that comprises the control channel 140 is known to each of the other control servers 141-143 in the path, and each control server 141-143 forwards on the control message to the next control server 141-143 in the path, changing the destination and source message header fields in conventional fashion.

### Data Channel

The data channel 130, when established between device D_{A} 110 and device D_{B} 120 as described herein, may receive data messages from router R_{A} 115 and transmit them to router R_{B} 125 and may receive data messages from router R_{B} 125 and transmit them to router R_{A} 115. In some example embodiments, the data channel 130 provides User Datagram Protocol (UDP) or Transmission Control Protocol (TCP) connectivity between device D_{A} 110 and device D_{B} 120.

In some example embodiments, when the data channel 130 has been established, a data message, sent from device D_{A} 110 through router R_{A} 115 and intended for device D_{B} 120, will indicate in the payload of the data message that the data message is intended for device D_{B} 120, and have the destination message header field populated with the public coordinates of device D_{B} 120. One or more packets from a data source to be transmitted by device D_{A} 110 to device D_{B} 120 may be added to the payload of the data message. In some example embodiments, these data packets are tagged with a file transfer identifier to facilitate reconstruction of the data source by device D_{B} 120.

The desired data channel is shown generally at 130, across a network 100, in which both devices are hidden behind routers 115, 125. The desired data channel 130 may comprise a path extending between each device 110, 120 and encompassing one or more intermediate routers (not shown). Alternatively, the data channel 130 could be a direct connection between router R_{A} 115 and router R_{B} 125.

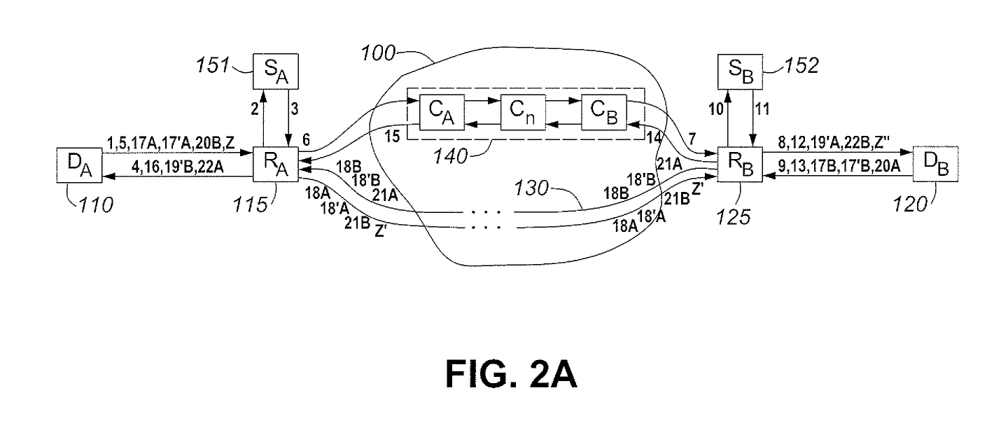

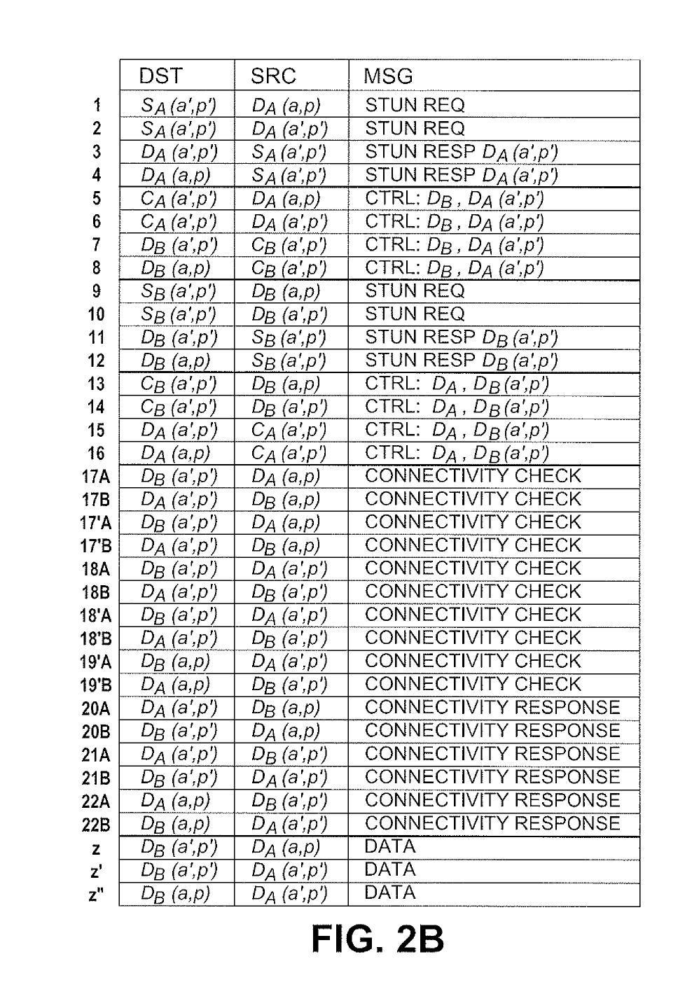

Example embodiments showing example processing steps for establishment or encryption or both of the data channel 130 will now be described having reference to FIGS. 2A through 7. FIGS. 2A, 3A, 5A and 6A are based on FIG. 1, but show specific message flows between the devices and nodes described thereon.

Message flows for the purposes of exchanging control information to set up and effect data communications between device D_{A} 110 and device D_{B} 120 are represented by numbered messages in FIGS. 2A, 3A, 5A and 6A. The content of each message is shown, organized by message number, in the complementary tables shown in FIGS. 2B, 3B, 5B and 6B.

Each of these messages shown in FIGS. 2B, 3B, 5B and 6B may be understood conceptually to be of the format:

| | | |
|---|---|---|
| DST | SRC | MSG |

where DST is the destination message header field, and represents the coordinates associated with the intended recipient of the message;
SRC is the source message header field, and represents the coordinates associated with the originator of the message; and
MSG is the payload or data portion of the message.

### Establishing the Data Channel

Turning now to FIG. 2A, there are shown example message flows between the two devices 110, 120, their respective routers 115, 125, the data channel 130, the control channel 140 and control servers 141-143 and the STUN servers 151, 152, in order to establish data channel 130 and initiate communications from device D_{A} 110 to device D_{B} 120 along the data channel 130. The formats of the example message flows are shown in the table at FIG. 2B.

By way of non-limiting example, a protocol for the establishment of the data channel 130 and known as “hole-punching” is described. This protocol follows 5 actions: (a) discovery by device D_{A} 110 of its public coordinates; (b) transmission of public coordinates by device D_{A} 110 to device D_{B} 120; (c) discovery by device D_{B} 120 of its public coordinates; (d) transmission of public coordinates by device D_{B} 120 to device D_{A} 110; and (e) connectivity testing. As is typical for some data channel establishment protocols, the hole-punching protocol involves the exchange of one or more control messages between devices D_{A} 110 and device D_{B} 120, across the control channel 130

The first action, that of discovery by device D_{A} 110 of its public coordinates, occupies STUN messages (1)-(4). This action serves two purposes. First, it establishes public coordinates for device D_{A} 110. Second, it communicates these public coordinates back to device D_{A} 110. Device D_{A} 110 transmits a STUN request message (1) to router R_{A} 115, comprising the public coordinates of STUN server S_{A} 151 as its destination message header field and its own private coordinates as its source message header field.

STUN request message (1) is received by router R_{A} 115, which identifies public coordinates for device D_{A} 110, adds the public coordinates of STUN server S_{A} 151 to its translation table and overwrites the source message header field with the public coordinates for device D_{A} 110, and forwards the amended STUN request message (2) to STUN server S_{A} 151.

Upon receipt of STUN request message (2) from router R_{A} 115, STUN server S_{A} 151 generates and transmits back to router R_{A} 115, a STUN response message (3), comprising the public coordinates of device D_{A} 110 as its destination message header field as part of the message payload, and the public coordinates as its source message header field.

STUN response message (3) is received by router R_{A} 115, which checks the source message header field against its translation table, and finding a corresponding entry, forwards the amended STUN response message (4) to device D_{A} 110, after having overwritten the destination message header field with the private coordinates for device D_{A} 110.

The second action, that of transmission of public coordinates by device D_{A} 110 to device D_{B} 120, occupies control messages (5)-(8). Device D_{A} 110, which knows its public coordinates from the previous action, formulates a control message (5) that contains the public coordinates for device D_{A} 110 in the control message payload along with an indication that the control message is intended for device D_{B} 120. The destination message header field in control message (5) comprises the public coordinates for the control server C_{A} 141 associated with device D_{A} 110, and the source message header field comprises device D_{A} 110's own private coordinates.

Control message (5) is received by router R_{A} 115, which confirms that the public coordinates of control server C_{A} 141 have been added to its translation table and overwrites the source message header field with the public coordinates for device D_{A} 110, and forwards the amended control message (6) to control server C_{A} 141.

Each control server 141-143 in turn overwrites the destination message header field in the control message with the public coordinates of the next control server 141-143 in the path of the control channel 140 and overwrites the source message header field with its own public coordinates, and forwards the thus amended control message (6) onward until the amended control message (6) eventually arrives at control server C_{B} 142.

Control server C_{B} 142, which recognizes that the control message (6) is intended for device D_{B} 120, overwrites the destination message header field in the control message with the public coordinates of device D_{B} 120 (which the control server C_{B} 142 knows from its initial outbound connection message discussed previously), overwrites the source message header field with its own public coordinates and forwards the amended control message (7) to router R_{B} 125.

Control message (7) is received by router R_{B} 125, which checks the source header field against its translation table, and finding a corresponding entry, forwards the amended control message (8) to device D_{B} 120, after having overwritten the destination message header field with the private coordinates for device D_{B} 120.

Control message (8) serves as a request to device D_{B} 120 to open a data channel 130 with device D_{A} 110, prompting device D_{B} 120 to commence the third action of the “hole punching” protocol, namely discovery by device D_{B} 120 of its public coordinates, which occupies messages (9) through (12). In this regard, device D_{B} 120, router R_{B} 125 and STUN server S_{B} 152 exchange STUN messages (9) through (12) in a similar manner as device D_{A} 110, router R_{A} 115 and STUN server S_{A} 151 exchange STUN messages (1) through (4). For example, device D_{B} 120 transmits a STUN request message (9) to router R_{B} 125, comprising the public coordinates of STUN server S_{B} 152 as its destination message header field and the private coordinates of device D_{B} 120 as its source message header field.

STUN request message (9) is received by router R_{B} 125, which identifies public coordinates for device D_{B} 120, adds the public coordinates of STUN server S_{B} 152 to its translation table and overwrites the source message header field with the public coordinates for device D_{B} 120, and forwards the message (10) to STUN server S_{B} 152.

Upon receipt of message (10) from router R_{B} 125, STUN server S_{B} 152 generates and transmits back to router R_{B} 125, a STUN response message (11), comprising the public coordinates of device D_{B} 120 as its destination message header field as part of the message payload, and its own public coordinates as its source message header field.

STUN response message (11) is received by router R_{B} 125, which checks the source message header field against its translation table, and finding a corresponding entry, forwards amended STUN response message (12) to device D_{B} 120, after having overwritten the destination message header field in control message (11) with the private coordinates for device D_{B} 120.

The fourth action, that of transmission of public coordinates by device D_{B} 120 to device D_{A} 110, occupies control messages (13) through (16), which are similar to control messages (5) through (8) discussed above. In particular, device D_{B} 120, which knows its public coordinates from the previous action, formulates a control message (13) that contains its public coordinates in the control message payload along with an indication that the control message is intended for device D_{A} 110. The destination message header field of control message (13) comprises the public coordinates for the control server C_{B} 142 associated with device D_{B} 120 and the source message header field of control message (13) comprises the private coordinates of device D_{B} 120.

Control message (13) is received by router R_{B} 125, which confirms that the public coordinates of control server C_{B} 142 have been added to its translation table and overwrites the source message header field with the public coordinates for device D_{B} 120, and forwards the amended control message (14) to control server C_{B} 142.

Each control server 141-143 in turn overwrites the destination message header field with the public coordinates of the next control server 141-143 in the path of the control channel 140 and overwrites the source message header field with its own public coordinates, and forwards the thus amended control message (14) onward until the amended control message (14) eventually arrives at control server C_{A} 141.

Control server C_{A} 141, which recognizes that the control message (14) is intended for device D_{A} 110, overwrites the destination message header field with the public coordinates of device D_{A} 110 (which the control server C_{A} 141 knows from its initial outbound connection message discussed previously), overwrites the source message header field with its own public coordinates and forwards the amended control message (15) to router R_{A} 115.

Control message (15) is received by router R_{A} 115, which checks the source header field against its translation table, and finding a corresponding entry, forwards the message (16) to device D_{A} 110, after having overwritten the destination message header field with the private coordinates for device D_{A} 110.

The fifth action in the hole-punching protocol, that of connectivity testing, occupies data messages (17) through (22) and is performed to finalize set up of the data channel 130 through network 100. During hole-punching, device D_{A} 110 sends a connectivity check data message (17A) to the public coordinates of device D_{B} 120. Similarly, device D_{B} 120 sends a connectivity check data message (17B) to the public coordinates of device D_{A} 110.

Connectivity check data message (17A) is received by router R_{A} 115, which confirms that the public coordinates of device D_{B} 120 have been added to its translation table and overwrites the source message header field of message (17A) with the public coordinates for device D_{A} 110, and forwards the amended connectivity check data message (18A) to router R_{B} 125 through network 100.

Similarly, connectivity data message (17B) is received by router R_{B} 125, which confirms that the public coordinates of device D_{A} 110 have been added to its translation table and overwrites the source message header field of connectivity message (17B) with the public coordinates for device D_{B} 120, and forwards the amended connectivity check data message (18B) to router R_{A} 115.

Connectivity check data message (18A) is received by router R_{B} 125, which checks the source header field against its translation table. Depending upon the timing of the connectivity check data messages (17A), (18A), (17B) and (18B), there may or may not be a corresponding entry. If there is no translation table entry in router R_{B} 125 corresponding to an outbound communication from device D_{B} 120 to device D_{A} 110 (i.e. connectivity check data message (17B)), connectivity check data message (18A) is not forwarded to device D_{B} 120.

Similarly, connectivity check data message (18B) is received by router R_{A} 115, which checks the source header field against its translation table. Depending upon the timing of the messages (17A), (18A), (17B) and (18B), there may or may not be a corresponding entry. If there is no translation table entry in router R_{A} 115 corresponding to an outbound communication from device D_{A} 110 to device D_{B} 120 (i.e. connectivity check data message (17A)), connectivity check data message (18A) is not forwarded to device D_{A} 110.

Devices D_{A} 110 and D_{B} 120 are each configured to periodically send out respective connectivity check data messages (17A), (17B) until they each receive a corresponding connectivity response data message (22A), (22B) (discussed in more detail below) or a predetermined time out event occurs. Accordingly, the exchange of connectivity check data messages will continue until, for example, as shown in FIG. 2A, the initial outgoing connectivity check data message (17A) from device D_{A} 110 reaches router R_{A} 115 before the subsequent incoming connectivity check data message (18′B) reaches router R_{A} 115, whereupon the subsequent incoming connectivity check data message (18′B) will be recognized by router R_{A} 115 and forwarded onto device D_{A} 110 as connectivity check data message (19′B), after having overwritten the destination message header field with the private coordinates for device D_{A} 110, and in the other direction, until the initial outgoing connectivity check data message (17B) from device D_{B} 120 reaches router R_{B} 125 before the subsequent incoming connectivity check message (18′A) reaches router R_{B} 125, whereupon the subsequent incoming connectivity check data message (18′A) will be recognized by router R_{B} 125 and forwarded onto device D_{B} 120 as connectivity check data message (19′A) after having overwritten the destination message header field with the private coordinates for device D_{B} 120.

In some cases, the first set of connectivity check data messages will be successfully received at the respective routers R_{A} 115, R_{B} 125 within the correct timing windows. However, due to differences in the speed at which the connectivity check data messages (17A), (17B) may travel across the network 100, this may not happen. In the example scenario shown in FIG. 2A, this is exemplified by the absence of connectivity check data messages (19A) and (19B), corresponding to connectivity check data messages (18A) and (18B), signifying that the initial incoming connectivity check data message (18A) reached router R_{B} 125 before the initial outgoing connectivity check data message (17B) did and that the initial incoming connectivity check data message (18B) reached router R_{A} 115 before the initial outgoing connectivity check data message (17A) did.

The number of incoming connectivity check data messages (18B) received at router R_{A} 115 before the initial outgoing connectivity check message (17A) is received may not be equal to the number of incoming connectivity check data messages (18A) received at router R_{B} 125 before the initial outgoing connectivity check data message (17B) is received. Moreover, it is possible that one or more outgoing connectivity check data messages (17A), (17B) may be lost by a router 115, 125, so that it is a subsequent outgoing connectivity check data message (e.g. (17′A), (17′B), where “'” denotes a repeated message) that will populate the translation table and permit reception of subsequent incoming connectivity check data messages (18′A), (18′B).

Once device D_{A} 110 receives its incoming connectivity check message (19′B), device D_{A} 110 transmits a connectivity response data message (20B, 21B, 22B) back along the data channel 130 to the public coordinates of device D_{B} 120. Similarly, once device D_{B} 120 receives its incoming connectivity check message (19′A), device D_{B} 120 transmits a connectivity response data message (20A, 21A, 22A) back along the data channel 130 to the public coordinates of device D_{A} 110.

Thus, both device D_{A} 110 and device D_{B} 120 continue to send their respective connectivity check data messages (17A), (17B) until they receive their respective connectivity response data message (22A), (22B). Once both connectivity response messages (22A), (22B) have been received, the data channel 130 has been set up and connectivity will have been provided between the devices D_{A} 110 and D_{B} 120, for example, a direct UDP/TCP connectivity.

This connectivity allows secure or efficient or secure and efficient transfer of a data source from one of the devices 110, 120 to the other device 120, 110, or vice versa. The data source being transferred may by way of non-limiting example be an e-mail message file, an image file, a media file such as a video or audio file, an application file containing executable code, or other type of file.

In some example embodiments, the data sending device 110 or 120 assigns a file transfer identifier to a data source that is to be transferred. Thus, when any data packets are selected for transmission, they are tagged with the file transfer identifier, so as to facilitate reconstruction of the data source at the data receiving device 120, 110.

Thus, in FIGS. 2A and 2B, message traffic containing data packets may be sent by either device 110, 120 along the data channel 130. For example, representative data messages (z), (z′) and (z″) from device D_{A} 110 to device D_{B} 120 are shown in FIGS. 2A and 2B.

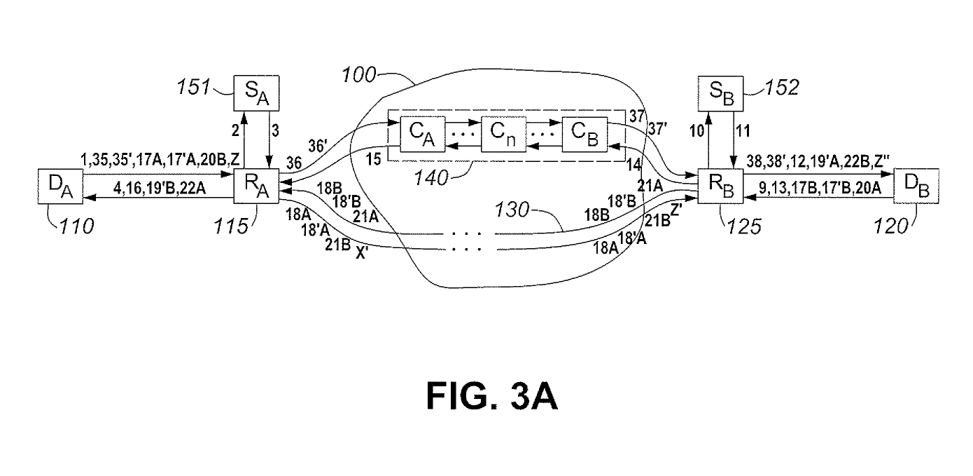

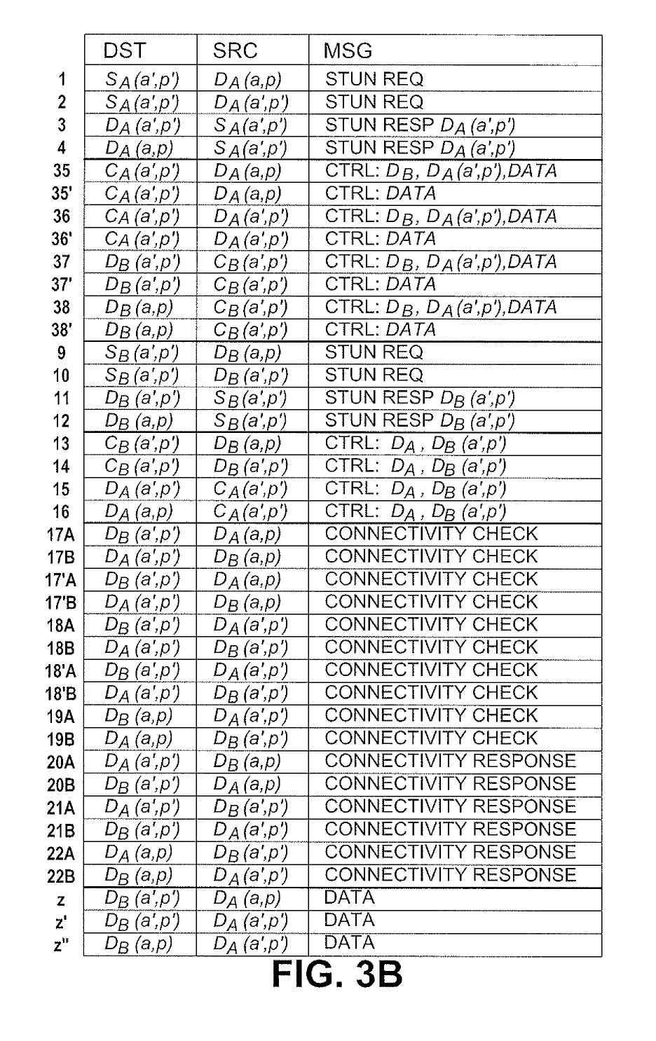

Turning now to FIG. 3A, there is shown a corresponding example message flow in accordance with an example embodiment of the present disclosure. The content of the example message flows is represented in the table at FIG. 3B. The embodiment shown in FIGS. 3A and 3B is similar to that shown in FIGS. 2A and 2B, with differences that will be apparent from the Figures and the following description. This embodiment shown in FIGS. 3A and 3B takes advantage of the fact that during the delay in setting up the data channel 130, the hole punching technique described in FIG. 2A results in the exchange of several control messages (5)-(8), (13)-(16) containing data across the control channel 140 before messages (z), (z′) and (z″) containing data packets tagged with the file transfer identifier are sent across the data channel 130.

The method disclosed in FIGS. 3A and 3B seeks to reduce the latency in transmitting data between devices 110 and 120 by sending some data from a data source to be transferred over the control channel 140 during the time that the hole punching protocol is being carried out, and then sending remaining data from the data source over the data channel 130 once it has been established.

As noted above, the control messages (5)-(8), (13)-(16) contain data in their respective message payloads (namely the identity of the desired destination device and the public coordinates of the originating device). The embodiment of FIGS. 3A and 3B recognizes that additional tagged data packets from a data source can also be transmitted along the control channel 140. Thus, the set-up latency inherent in establishing the data channel 130 may be reduced by transmitting tagged data packets from a data source as part of the message payload of control messages, before the data channel 130 has been established.

One or more initial tagged data packets are transmitted as part of control messages (35)-(38) as shown in FIG. 3A (assuming that the desired data packet(s) are to be sent from device D_{A} 110 to device D_{B} 120). Control messages (35)-(38) are similar to control messages (5)-(8) in that the control message includes the identity of the desired destination device and the public coordinates of the originating device within the message payload, however the payload of control messages (35)-(38) also includes additional tagged data packets extracted from tagged data packets that would otherwise have been sent through the data channel 130 after the data channel 130 was established. Additional tagged data packets can also be transmitted in additional control messages (35′)-(38′) along the control channel 140 as appropriate, which messages are not strictly involved in establishing the data channel 130, but are sent to take advantage of available bandwidth while the the data channel 130 establishment protocol is being performed by the exchange of messages (9)-(22). Accordingly, unlike control messages (45)-(48), the control messages (35′)-(38′) do not contain any other data within the message payload, but only the tagged data packets to be transmitted.

The file transfer identifier used to tag the tagged data packets can be used by the data receiving device 120, 110 to reassemble the data source from the tagged data packets that are received through the control channel 140 and the remaining tagged data packets that are subsequently sent through the data channel 130 once it is established.

As discussed, the message flows of FIG. 3A assume that the tagged data packet(s) are to be transmitted from device D_{A} 110 to device D_{B} 120. Additionally, or alternatively, tagged data packet(s) could be transmitted in similar fashion from device D_{B} 120 to device D_{A} 110 in the message payload of control messages (13)-(16) and in additional control messages while the data channel 130 is being established.

It is typical to establish a peer to peer data channel 130 and to restrict use of the control channel 140 to facilitate the set up of peer to peer data channels 130, because the use of peer to peer data channels 130 helps to avoid centralization of communications and attendant bottlenecks and security concerns that may result. Nevertheless, in the embodiment of FIG. 3A, even though extra data packet(s) from a data source are being sent through the control channel 140 as opposed to exclusively through the data channel 130, traffic volume and security issues are, in at least some applications, negligible, as the hole punching protocol already permits some data transmission (such as address information) along the control channel 140 and thus assumes that transmission along the control channel 140 is secure, and the extra tagged data packets are transmitted in the control channel 140 only for a limited time period until the data channel 130 is established.

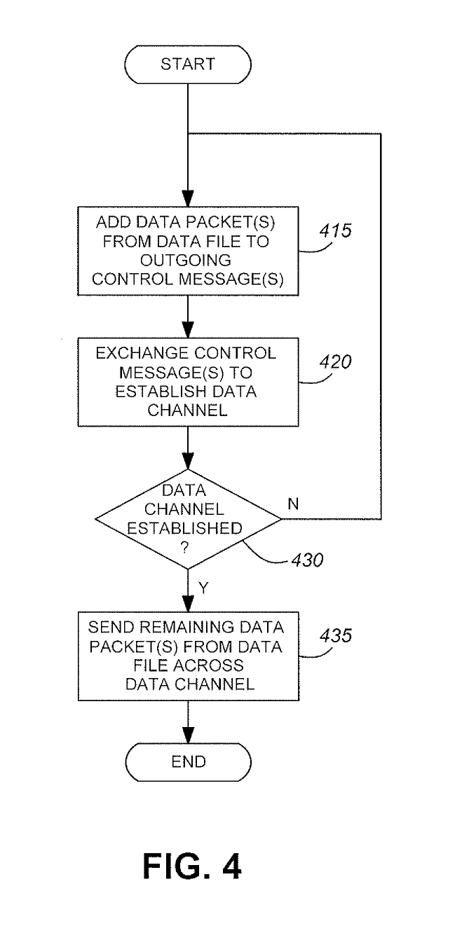

Turning now to FIG. 4, there is shown a flow chart showing example processing actions for a device, for example, device D_{A} 110 to establish a data channel 130 with another device, for example, device D_{B} 120, with reduced set up latency for transmission of data packet(s) from a data source by the device D_{A} 110 to another device D_{B} 120 in accordance with one or more embodiments disclosed herein.

As described in detail in the example embodiments described above in respect of FIGS. 3A and 3B, as shown in action 415, at least one data packet, tagged with the file transfer identifier, is added to the payload of at least one outgoing control message to be transmitted along the control channel 140 by a device, for example, in this case, device D_{A} 110 and intended for device D_{B} 120. Accordingly, this control message is sent before the data channel 130 has been established.

Upon adding the at least one tagged data packet to the control message (action 415), the control message is then transmitted (action 420) along the control channel 140 as one of the control messages exchanged between the devices 110, 120 as part of the protocol for establishing the data channel 130.

It will be appreciated that additionally, or alternatively, device D_{B} 120 may have a data source to be transmitted to device D_{A} 110, with the result that at least one data packet, tagged with a file transfer identifier, may have been added to an incoming control message along the control channel 140 which may be received as part of the protocol for establishing the data channel 130 (action 420) by device D_{A} 110. If such is the case, then the added tagged data packet may be retrieved from the incoming control message.

As indicated in decision box 430, a check is done to see if the data channel 130 has been established. If not, then additional control messages may be exchanged in the manner discussed above in respect of actions 415-425 in order to establish the data channel 130.

Once the data channel 130 has been established, device D_{A} 110 may send the remaining data packet(s), tagged with the file transfer identifies for the data source identifier, in messages across the data channel 130 to device D_{B} 120, where they may be combined with the tagged data packets transferred in control messages (action 420) to reconstruct the data source.

### Exchanging the Encryption Key

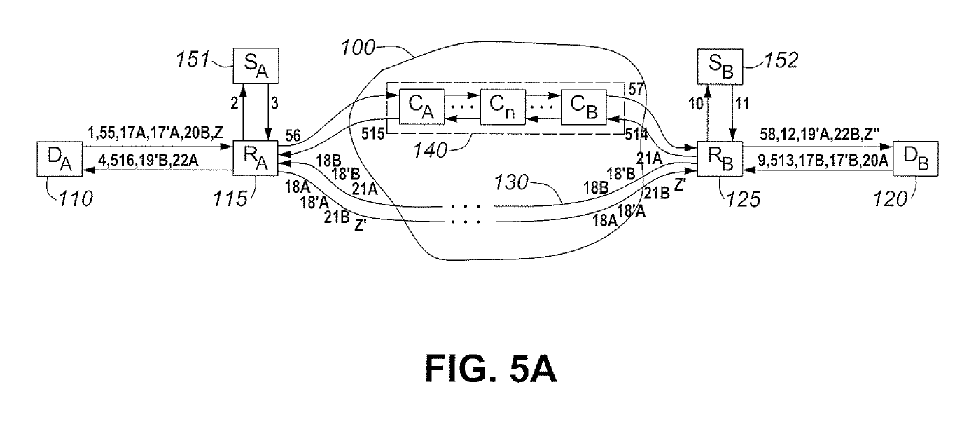

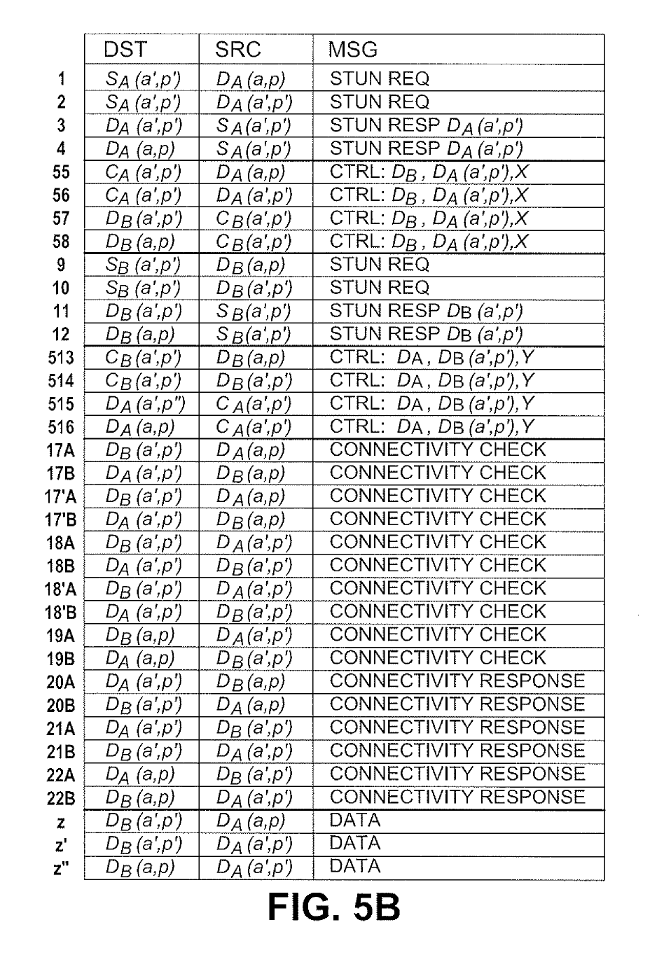

Turning now to FIGS. 5A and 5B, it may be desired to ensure that any tagged data packets passed between the devices remains secure. This may involve exchange of one or more control messages between device A 110 and device B 120, to give effect to a cryptographic protocol as discussed below.

The Diffie-Hellman key exchange cryptographic protocol, used as a non-limiting example, allows two parties that have no prior knowledge of each other to jointly establish a shared secret key k over an insecure communication channel. The protocol is described in U.S. Pat. No. 4,200,700 entitled “Cryptographic Apparatus and Method” issued Apr. 29, 1980 to Hellman et al. The key k can then be used to encrypt data at one end of the data channel 130 and decrypt the data at the other end of the data channel 130. One of the hallmarks of the Diffie-Hellman key exchange protocol is that the protocol guarantees perfect forward secrecy, with the result that even if a third party steals the long-term secrets of two communicating parties, the attacker will still not be able to decrypt the messages that were exchanged before the secrets were stolen.

Under the Diffie-Hellman key exchange cryptography protocol, the key k may be derived from the formula:

k=X^{y} mod p=Y^{x} mod p (1)

where k is the key,

p is a prime number known to both devices,

g is a number known to both devices, that satisfies the following property: for any i in {1, 2, . . . , p-1}, there exists an integer x such that i=g^{x} mod p, typically either 2 or 5,

X is the result of a calculation performed by a first device in accordance with

X=g^{x} mod p, (2)

where x is a secret integer known only to the first device, and

Y is the result of a calculation performed by a second device in accordance with

Y=g mod p, (3)

where y is a secret integer known only to the second device.

Because:

X^{y} mod p=(g^{x} mod p=g^{xy} mod p, and (4)

Y^{x} mod p=(g^{y} mod=g^{yx} mod p=g^{xy} mod p, (5)

it may be seen that the key k may be derived by the first device through only knowledge of the values of x, p, g and Y, and by the second device through only knowledge of the values of y, p, g and X, and X and Y may be transmitted in the clear by the first device and second device respectively to the second device and first device respectively. By contrast, a third party armed with the values of p, g and X and Y would not be able to discern the value of the key k without also obtaining knowledge of either x or y.

Thus, in order to establish a key k for a data channel 130, the devices 110, 120 will have a priori agreed-upon values for p and g and for the purposes of encrypting the data channel 130, one will adopt a value for x and the other will adopt a value for y. Typically, large values are chosen for these values to prevent the likelihood of brute force decryption.

As part of the Diffie-Hellman key exchange protocol, a number of control messages are initiated by each device 110, 120. These messages may be transmitted roughly simultaneously (subject to differences in processor speed or loading or both and complexity of computation, having regard to different values for x and y selected by device D_{A} 110 and device D_{B} 120 respectively).

There may be a considerable delay before either device 110, 120 transmits its initial Diffie-Hellman message, having regard to the significant computation that may be entailed in performing the calculations of Equations (2) and (3) respectively. The delay may be not be the same for either device 110, 120 having regard to differences in processor speed or loading or both and complexity of computation using the different values for x and y selected by device D_{A} 110 and device D_{B} 120 respectively.

As shown in the non-limiting example of FIGS. 5A and 5B, device D_{A} 110 may transmit its computed value of cleartext expression X in the message payload of the initial control message (55)-(58) transmitted by device D_{A} 110 to device D_{B} 120 and device D_{B} 120 may transmit its computed value of cleartext expression Y in the message payload of the initial control message (513)-(516) transmitted by device D_{B} 120 to device D_{A} 110. In other example embodiments, additional control messages having only the computed values of cleartext expressions X or Y may be exchanged, leaving control messages (5)-(8) unaltered.

At this point, upon receipt of message (58), device D_{B} 120 may extract the value of cleartext expression X from the message payload of message (58) and proceed with a computation of the shared key k, based upon Equation (5). By the same token, upon receipt of message (516), device D_{A} 110 may extract the value of cleartext expression Y from the message payload of message (516) and proceed with a computation of the shared key k, based upon Equation (4). Again, there may be a considerable delay in so doing, having regard to the significant computation that may be entailed in performing the calculations of Equations (4) and (5) respectively and having regard to differences in processor speed or loading or both and complexity of computation using the different values for x and y selected by device A 110 and device B 120 respectively, as well as the delay between the transmission of message (55)-(58) and of message (513)-(516).

In any event, once the shared key k is known to both device A 110 and device B 120, either or both device can then proceed to securely transmit data packets (tagged with a file transfer identifier) along the data channel 130 as messages (z), (z′), (z″) encrypted by shared key k.

However, because the tagged data packet(s) to be transferred are to be encrypted using shared key k, which will not have been established and known by both devices until at least after the receipt by device D_{A} 110 of message (516), the transmission of tagged data packet(s) by device D_{A} 110 in the example embodiment of FIGS. 4A and 4B as control message (45)-(48) and encrypted by shared key k is notionally precluded because shared key k is not yet known. Conceivably, however, provided that their transmission is delayed until after receipt of message (516), the additional control messages (35′)-(38′) may be encrypted by shared key k and data transmitted along the control channel 140 thereby, so as to at least somewhat reduce the set-up latency of the data channel 130.

Even so, the set-up latency of the data channel 130 before data may be exchanged may be significantly increased, both from the computation involved in developing the key k and in the exchange of the messages back and forth.

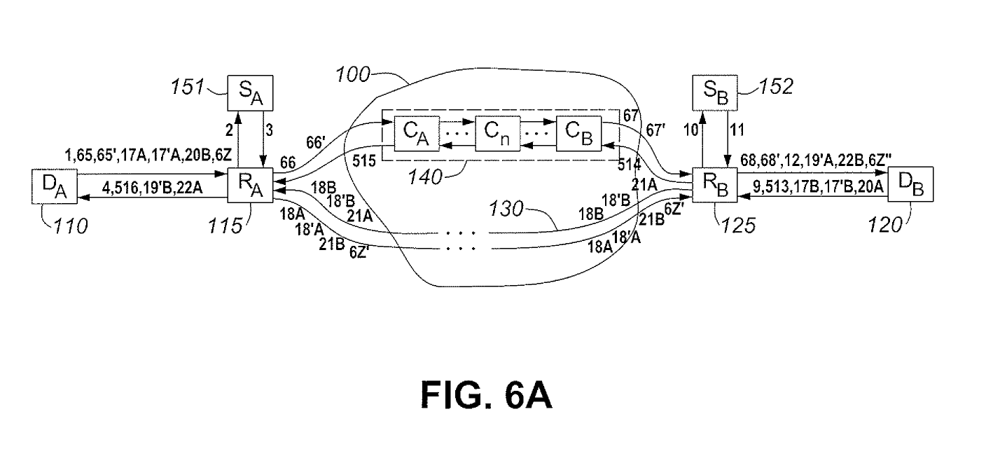

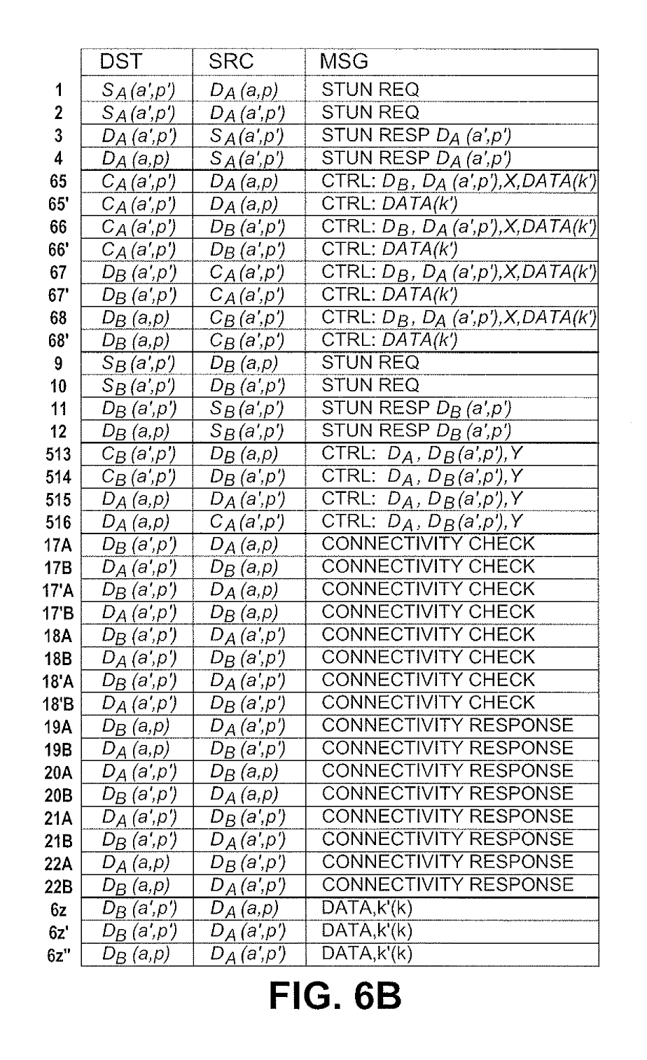

FIGS. 6A and 6B, however, illustrate an example embodiment whereby considerable set up latency reduction, on the scale achieved by or even exceeding the example embodiment of FIGS. 3A and 3B may be achieved while ensuring that each tagged data packet is encrypted, even before the shared key k has been established and is known to both devices.

In order to overcome the fact that at the time such tagged data packets are transmitted, the shared key k has not yet been established, this embodiment makes use of one or the other or both of temporary keys k′ and k″ to encrypt the tagged data packets transmitted over the control channel 140, and then once the data channel 130 and the shared key k have been established the encrypting device transmits the temporary keys k″ and k′ to the other device across the data channel 130, encrypted with the shared key k.

Thus, by way of non-limiting example, if device D_{A} 110 had a data source to be transmitted to device D_{B} 120, one or more initial tagged data packets could be transmitted as part of control messages (65)-(68) as shown in FIGS. 6A and 6B, with the data packets encrypted using temporary key k′ established unilaterally by device D_{A} 110, added to the other data (identity of the desired destination and the public coordinates of the originating device) within the message payload. Again, additional tagged packets may be transmitted in additional control messages (65′)-(68′) along the control channel 130 thereafter as appropriate, while the remainder of the hole punching protocol is being performed (9)-(22).

The message flows of FIGS. 6A and 6B assume that tagged data packet(s) are to be transmitted from device D_{A} 110 to device D_{B} 120. Additionally, or alternatively, tagged data packet(s) could be transmitted in similar fashion from device D_{B} 120 to device D_{A} 110 in the message payload of control messages (13)-(16) and in additional control messages while the remainder of the hole punching protocol is being performed (17)-(22).

Thus, by the time that the shared key k has been established, a number of tagged data packets may have been transmitted between device D_{A} 110 and device D_{B} 120 along the control channel 130, in secure fashion, being encrypted by temporary key k′ known only (to this point) by device D_{A} 110 or by temporary key k″ known only (to this point) by device D_{B} 120. Because device D_{B} 120 does not yet know temporary key k′ and device D_{A} 110 does not yet know temporary key k″, these tagged data packets remain unprocessed. However, some of the latency that would otherwise be incurred in establishing the shared key k before transmitting such tagged data packets has been avoided.

In any event, now that the shared key k has been established, device D_{A} 110 may thereafter send further messages along the data channel 130 containing the remaining tagged data packets from the data source in the message payload that are encrypted by shared key k and thus safe from third party interception. One of the first such messages (z), (z′) and (z″) may also comprise encrypted key information comprising the temporary key k′, encrypted by shared key k.

In the same fashion, device D_{B} 120 may send a message (not shown) along the data channel 130 containing tagged data packets in the message payload that are encrypted by shared key k and thus safe from third party interception. One of the first such messages comprises encrypted key information comprising the temporary key k″, encrypted by shared key k.

Once temporary key k′ has been received (in encrypted form) and is decrypted by device D_{B} 120 using the shared key k, the previously received tagged data packets encrypted using temporary key k′ and transmitted by control messages (65)-(68), or (65′)-(68′) or both may be decrypted using the temporary key k′ and processed by device D_{B} 120 with the remaining tagged data packets transmitted along the data channel 130 to reconstruct the data source transferred from device D_{A} 110 to device D_{B} 120.

Similarly, once temporary key k″ has been received (in encrypted form) and decrypted by device D_{A} 110, the previously received tagged data packets encrypted using temporary key k″ and transmitted by control messages (not shown) may be decrypted using the temporary key k″ and processed by device D_{A} 110 with the remaining tagged data packets transmitted along the data channel 130 to reconstruct the data source transferred from device D_{B} 120 to device D_{A} 110.

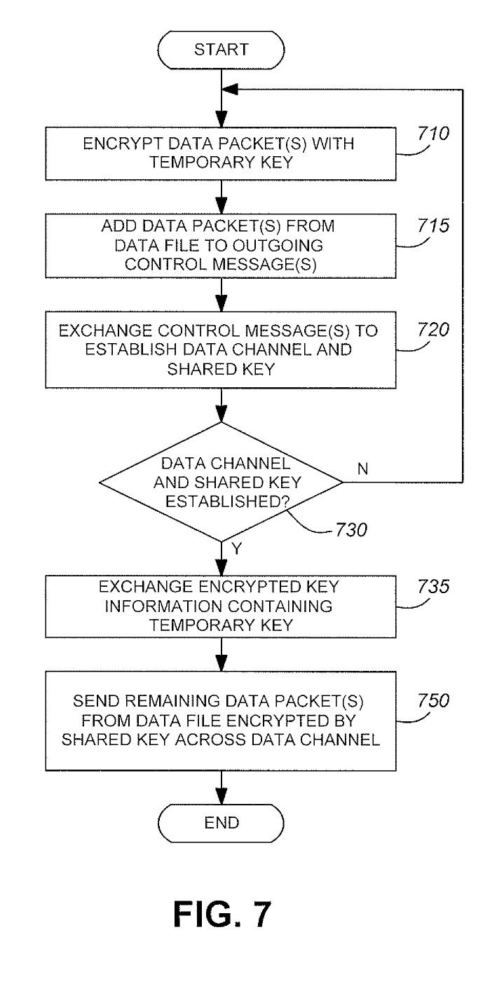

Turning now to FIG. 7, there is shown a flow chart showing example processing actions for a device, for example, device D_{A} 110, to establish an shared key encrypted data channel 130 with another device, for example, device D_{B} 120, with reduced set up latency before transmission of data packets from a data source may be transmitted by the device D_{A} 110 to another device D_{B} 120 in accordance with one or more embodiments disclosed herein.

As described in detail in the example embodiments described above in respect of FIGS. 6A and 6B, as shown in action 710, prior to being added to the payload of the at least one outgoing control message (action 715 below), at least one data packet, tagged with the file transfer identifier, may be encrypted with a temporary key k′ selected by device D_{A} 110 and known only to device D_{A} 110.

Thereafter, at action 715, the tagged data packet(s) are added to the payload of at least one outgoing control message to be transmitted along the control channel 140 by a device, for example, in this case, device D_{A} 110 and intended for device D_{B} 120.

Upon adding the at least one tagged data packet to the control message (action 715), the control message is then transmitted (action 720) along the control channel 140 as one of the control messages exchanged between the devices 110, 120 as part of the protocol for establishing the data channel 130 or the shared key k or both. Accordingly, this control message is sent before the data channel 130 has been established.

It will be appreciated that additionally, or alternatively, device D_{B} 120 may have a data source to be transmitted to device D_{A} 110, with the result that at least one data packet, tagged with a file transfer identifier, may have been added to an incoming control message along the control channel 140 which may be received (action 720) by device D_{A} 110. If such is the case, then the added tagged data packet may be retrieved from the incoming control message.

As indicated in decision box 730, a check is done to see if both the data channel 130 and the shared key k have been established. If not, then additional control messages may be exchanged in the manner discussed above in respect of actions 710-725 in order to establish the data channel 130 and the shared key k.

Once the data channel 130 and the shared key k have been established, data packets, tagged with the file transfer identifier and encrypted with the shared key k, may thereafter be exchanged between the devices 110, 120 along the data channel 130 using the shared key k established through the exchange of control messages (such as those exchanged in action 720), where they may be combined with the tagged data packets transferred in control messages (action 720) to reconstruct the data source. As indicated in action 735, one of the first encrypted data packets to be exchanged will be the temporary key k′, k″ used by each of device D_{A} 110 and device D_{B} 120 to permit the other device to decrypt any tagged data packets encrypted with such temporary key prior to establishment of the shared key k.

### The Mobile Device

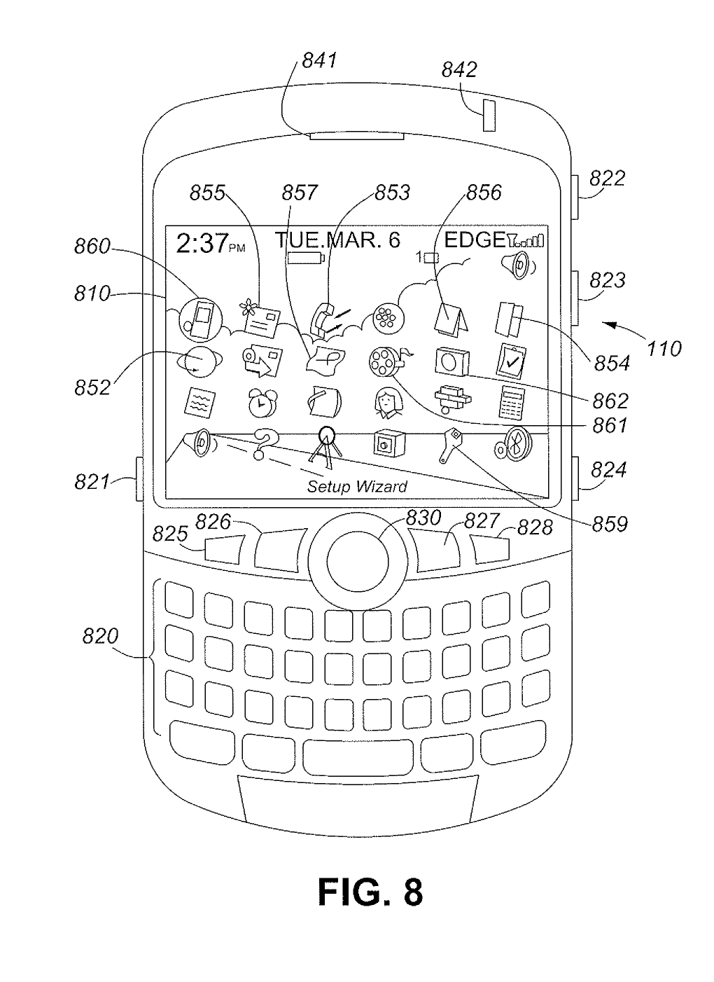

Referring now to FIG. 8, there is shown a graphical representation of a front view of an example of a mobile device 110 to which example embodiments described herein can be applied. The mobile device 110 has a two-way electronic messaging communications capabilities and possibly also voice communications capabilities. Depending on the functionality provided by the mobile device 110, in various embodiments the mobile device 110 may be a wireless handset, a data communications device, a multiple-mode communications device configured for both data and voice communication, a mobile telephone, a pager, a personal digital assistant (PDA), which may be enabled for wireless communications, a personal entertainment device, a telecommunications device installed within a vehicle, a portable, laptop, notebook and/or tablet computer with a wireless modem or wireless network card, or a portable, laptop, notebook and/or tablet computer or a phone device with a fixed connection to a network, among other things. Many suitable devices may combine some or all of these functions. The mobile device 110 may support specialized activities, such as gaming, inventory control, job control and/or task management functions and the like.

The mobile device 110 is, in at least one example embodiment, a handheld device having a casing or housing that is dimensioned to fit into a purse, pocket or belt-mounted device holster.

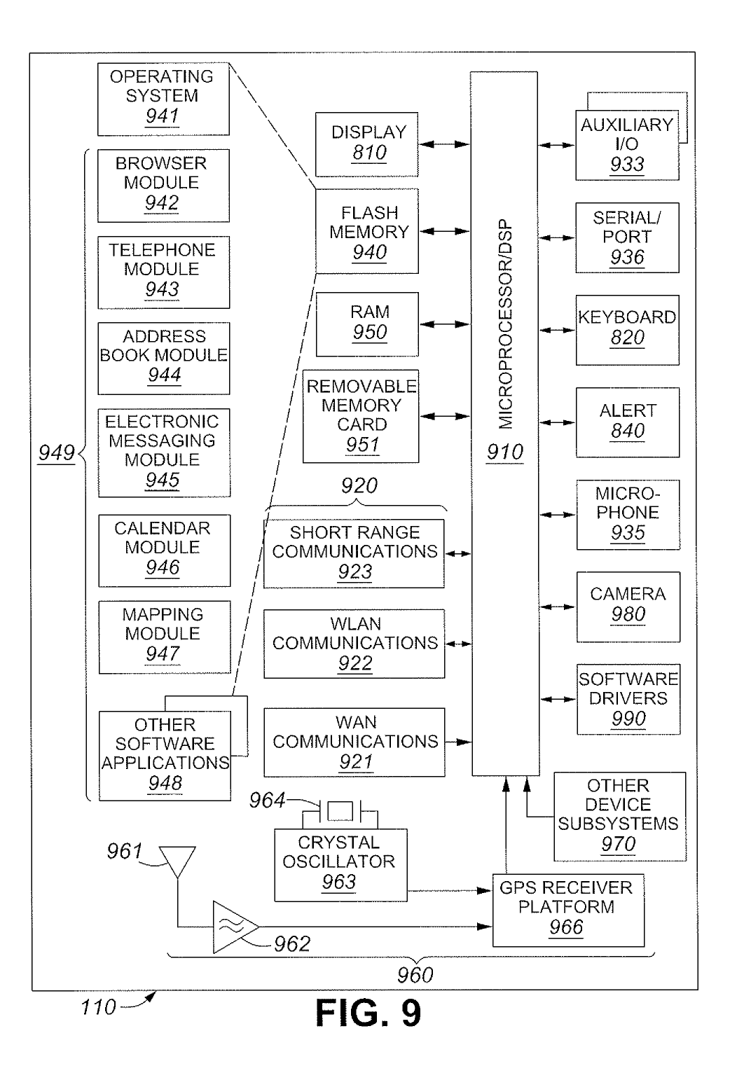

The mobile device 110 includes a display screen 810, an alphanumeric keyboard or keypad 820, optionally one or more non-keyboard inputs, such as buttons 821-828, which may be navigational, function, exit and/or escape keys, which may be inwardly depressed to provide further input function, or touch-sensitive areas (not shown) within the display screen 810, and/or a rotatable input device such as a trackball 830 or scrollwheel or trackwheel (not shown) and a speaker 841, visible indicator 842 or other alert 840 (shown on FIG. 9).

The keyboard or keypad 820 may comprise a touch-sensitive surface (not shown). In some example embodiments keys in the keyboard 820 may contain one or more letters aligned in a QWERTY layout. In some embodiments the keys in the keyboard 820 may not be actual physical keys but may be virtual keys displayed on a touch screen display (not shown). In some example embodiments, the keyboard 820 includes a QWERTZ layout, an AZERTY layout, a Dvorak layout, sequential type layouts or the like, or a traditional numeric keypad (not shown) with alphabetic letters associated with a telephone keypad. In some example embodiments, the keyboard 820 layout has reduced keys, such as a reduced QWERTY layout.

Referring now to FIG. 9, the mobile device 110 includes a controller that includes at least one microprocessor and/or digital signal processor (DSP) 910 for controlling the overall operation of the mobile device 110. The microprocessor/DSP 910 interacts with a communications subsystem shown generally at 920, and with further device subsystems such as display 810, which may include a touch-sensitive surface, keyboard or keypad 820, one or more auxiliary input/output (I/O) subsystems or devices 933 (e.g. trackball 830, non-keyboard inputs 821-828 or a scrollwheel or trackwheel (not shown) and their associated controllers), one or more alerts 840 (which may be audible 841, visible 842 and/or tactile (not shown)) and/or a headset port (not shown), a microphone 935, a serial port 936, which may be a universal serial bus (USB) port, a flash memory 940, random access memory (RAM) 950, a removable memory card 951, a charge-coupled device (CCD) camera 980, a global positioning system (GPS) (or other navigation) satellite receiver 960 (which may comprise an antenna 961, an amplifier 962, crystal oscillator 963, and GPS receiver platform 966), and any other device subsystems generally designated as 970.

The microprocessor/DSP 910 operates under stored program control of the operating system software and/or firmware 941 and various software and/or firmware applications 949 used by the microprocessor/DSP 910, which are, in one example embodiment, stored in a persistent store such as flash memory 940 or similar storage element. The operating system 941, software disclosures shown generally at 949, or parts thereof, may be temporarily loaded into a volatile store such as RAM 950.

The microprocessor/DSP 910 executes operating system drivers that provide a platform from which the rest of the software 941 and 949 operates. The operating system drivers 990 provide drivers for the wireless device hardware with standardized interfaces that are accessible to application software. The operating system drivers 990 include application management services (“AMS”) (not shown) that transfer control between applications running on the mobile device 110.

The microprocessor/DSP 910, in addition to its operating system 941 functions, in example embodiments, enables execution of software applications 949 for interacting with the various device subsystems of the mobile device 110, by presenting options for user-selection, controls for user-actuation, and/or cursors and/or other indicators for user-direction. The mobile device 110 may further accept user data entry, including numbers to dial or various parameter values for configuring the operation of the mobile device 110.

A predetermined set of software applications 949 may be executed in response to user commands to control basic device operations, including data and voice communication applications, such as a web browser module 942, a telephone module 943, an address book module 944, an electronic messaging module 945 (which may include e-mail, SMS messaging and/or PIN messaging) and a calendar module 946, for example, will normally be installed on the mobile device 110 during manufacture. Further software applications 948, such as a mapping module 947, a media player module (not shown), a camera module (not shown), one or more Java applications (not shown), may also be loaded onto the communications device 110 during manufacture, or through wired or wireless communications along the communications subsystem 920, the auxiliary I/O subsystem 933, serial port 936, information carrier media such as portable data storage media like the removable memory card 951, or any other suitable subsystem 970, and installed in the RAM 950 or a non-volatile store such as the flash memory 940 for execution by the microprocessor/DSP 910. These applications may configure the mobile device 110 to perform various customized functions in response to user interaction. Such flexibility in application installation increases the functionality of the mobile device 110 and may provide enhanced on-device functions, communication-related functions, or both. In some embodiments, some or part of the functionality of the functional modules can be implemented through firmware or hardware components instead of, or in combination with, computer software instructions executed by the microprocessor/DSP 910 (or other processors (not shown)).

Under instructions from various software applications 949 resident on the mobile device 110, the microprocessor/DSP 910 is configured to implement various functional components or modules, for interacting with the various device subsystems of the mobile device 110. Additionally, the microprocessor/DSP 910 may be configured and/or programmed over-the-air, for example from a wireless base station (not shown), a wireless access point (not shown), or a peer mobile device 110. The software application 949 may comprise a compiled set of machine-readable instructions that configure the microprocessor/DSP 910 to provide the desired functionality, or the software applications 949 may be high-level software instructions to be processed by an interpreter or compiler to indirectly configure the microprocessor/DSP 910.

The web browser module 942 enables the display 810 to show a web page and permits access to a specified web address, for example via data transfer over one or more of the communications subsystem 920 components, for example, by wireless communications with a wireless access point (not shown), a cell tower (not shown), a peer mobile device 110, or any other wireless communication network or system (not shown). Said network is coupled to a wired network, such as the Internet (not shown), through which the mobile device 110 may have access to information on various origin servers (not shown) for providing content for display on the display 810. Alternatively, the mobile device 110 may access the network through a peer mobile device 110, acting as an intermediary, in a relay type or hop-type connection.

The telephone module 943 enables the mobile device 110 to transmit and receive voice and/or data over one or more of the communications subsystem 920 components.

The address book module 945 enables address book information, such as telephone numbers, email and/or instant text messaging addresses and/or PIN numbers to be stored and accessed on the mobile device 110.

The electronic messaging module 945 enables the mobile device 110 to send and receive electronic messages over one or more of the communications subsystems 920 components. Examples of electronic messaging include email, personal identification number (PIN) messaging and/or short message service (SMS) messaging.

The calendar module 946 enables appointment and/or task information to be stored and accessed on the mobile device 110.

The mapping module 947 provides location-based services relative to the current location of the mobile device 110, including but not limited to storage, access and/or retrieval of detailed mapping information on the communications device 110 and provision of turn-by-turn directions from an initial map position to a desired destination map position in accordance therewith. Other location-based service modules (not shown) may include the E911 cellular phone positioning initiative of the Federal Communications Commission (FCC).

The media player application 948 configures the mobile device 110 to retrieve and play audio or audiovisual media. The camera application 948 configures the mobile device 110 to image and take still or motion video images. The Java applets 948 configure the mobile device 110 to provide games, utilities, and other functionality. One or more components might provide functionality related to speed measurement, disablement of device features, and/or overriding of the disablement of device features as described herein.

Referring briefly to FIG. 8 again, there is shown an example of a mobile device 110 on which a plurality of user selectable icons are shown on its display screen 810. The icons are each associated with functions that can be performed by the mobile device 110. For example, FIG. 8 shows a browser icon 852 for accessing web browsing functions (associated with browser module 942), a “Phone” icon 853 for accessing phone functionality (associated with telephone module 943), an “Address Book” icon 854 for accessing address book functions (associated with address book module 942), a “Messages” icon 855 for accessing electronic messaging functions of the communications device 110 (associated with electronic messaging module 945), a “Calendar” icon 856 for accessing calendar functions (associated with calendar module 946), a “Maps” icon 857 for accessing mapping functions (associated with mapping module 947), a “Media” icon 861 for accessing media player functions (associate with media player application 948), a “Camera” icon 862 for accessing camera functions (associated with the camera application 948) and an options icon 859 (associated with an options module, which may be a separate module or executed by one or more existing modules). An icon 850 is shown highlighted or focused by a caret or selection symbol 860 which can be navigated by a device user among the displayed icons through manipulation of the trackball 830 (or other navigational input device). The trackball 830 is also depressible, such that depression of the trackball 830 when an icon is highlighted or focused by selection symbol 860 results in the launch of functions of the associated module.

Each of the software disclosures 949 may include layout information defining the placement of particular fields, such as text fields, input fields, etc., in a user interface for the software disclosure 949.

In FIG. 9, the communications subsystem 920 acts as an interface between the mobile device 110 and a communications environment (not shown). As will be apparent to those skilled in the field of communications, the particular configuration of the communications subsystem 920 will be dependent upon the communications network(s) in the communications environment in which the communications device 110 is intended to operate, and may comprise one or more of a WAN communications module 921, a WLAN communications module 922, and a short-range communications module 923.

In the foregoing disclosure, for purposes of explanation and not limitation, specific details are set forth such as particular architectures, interfaces, techniques, etc. in order to provide a thorough understanding of the present disclosure. However, the present disclosure may be practised in other embodiments that depart from these specific details. All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The present disclosure can be implemented in digital electronic circuitry, or in computer hardware, firmware, software, or in combination thereof. Apparatus of the disclosure can be implemented in a computer program product tangibly embodied in a machine-readable storage device for execution by a programmable processor; and methods actions can be performed by a programmable processor executing a program of instructions to perform functions of the disclosure by operating on input data and generating output.

Generally, a computer will include one or more mass storage devices for storing data; such devices include magnetic disks and cards, such as internal hard disks, and removable disks and cards; magneto-optical disks; and optical disks. Storage devices suitable for tangibly embodying computer program instructions and data include all forms of volatile and non-volatile memory, including by way of example semiconductor memory devices, such as EPROM, EEPROM, and flash memory devices; magnetic disks such as internal hard disks and removable disks; magneto-optical disks; CD-ROM and DVD-ROM disks; and buffer circuits such as latches and flip flops. Any of the foregoing can be supplemented by, or incorporated in ASICs (application-specific integrated circuits), FPGAs (field-programmable gate arrays) or DSPs (digital signal processors).

Various modifications and variations may be made to the embodiments disclosed herein, consistent with the present disclosure, without departing from the spirit and scope of the present disclosure. While preferred embodiments are disclosed, this is not intended to be limiting. Rather, the general principles set forth herein are considered to be merely illustrative of the scope of the present disclosure and it is to be further understood that numerous changes covering alternatives, modifications and equivalents may be made without straying from the scope of the present disclosure, as defined by the appended claims.

Other embodiments consistent with the present application will become apparent from consideration of the specification and the practice of the disclosure disclosed herein.

What is claimed is:

1. A method for sending data from a first device to a second device over a network, comprising at the first device:
sending at least one control message to the second device along a control channel prior to establishing a data channel between the first device and the second device;
including some data from a data source in the at least one control message prior to establishing the data channel; and
sending remaining data from the data source to the second device along the data channel once the data channel has been established.

2. The method according to claim 1, comprising assigning a file transfer identifier to the data source and including the file transfer identifier with the data included in the at least one control message.

3. The method according to claim 2, comprising including the file transfer identifier with the remaining data for reassembling the data source at the second device.

4. The method according to claim 1, wherein the at least one control message is sent as part of a hole-punching protocol.

5. The method according to claim 4, wherein the first device is located behind a network address translation device, the first device exchanging at least one message with the associated network address translation device as part of the hole punching protocol.

6. The method according to claim 1, wherein the data included in the at least one control message is included as payload data in the at least one control message along with public address information of the first device.

7. The method according to claim 6, wherein the first device obtains public address information of the first device by exchanging at least one message with an associated STUN server in the network.

8. The method according to claim 1, wherein the at least one control message is sent to establish the data channel.

9. The method according to claim 1, further comprising:
encrypting the data included in the at least one control message with a temporary key;
encrypting key information identifying the temporary key with a further key known only to the first device and second device; and
sending the encrypted key information to the second device along the data channel, once the data channel has been established, for decrypting the data included in the at least one control message at the second device.

10. The method according to claim 9, wherein the further key is obtained by a Diffie-Hellman key exchange protocol.

11. A first device for sending data to a second device over a network, the first device for:
sending at least one control message to the second device along a control channel prior to establishing a data channel between the first device and the second device;
including some data from a data source in the at least one control message prior to establishing the data channel; and
sending remaining data from the data source to the second device along the data channel once the data channel has been established.

12. The first device according to claim 11, wherein the first device is a mobile device.

13. The first device according to claim 11, for:
assigning a file transfer identifier to the data source and including the file transfer identifier with the data included in the at least one control message.

14. The first device according to claim 13, for:
including the file transfer identifier with the remaining data for reassembling the data source at the second device.

15. The first device according to claim 11, for:
including the data in the at least one control message as payload data in the at least one control message along with public address information of the first device.

16. The first device according to claim 11 for sending the at least one control message to establish the data channel.

17. The first device according to claim 11 for:
encrypting the data included in the at least one control message with a temporary key;
encrypting key information identifying the temporary key with a further key known only to the first device and second device; and
sending the encrypted key information to the second device along the data channel, once the data channel has been established, for decrypting the data included in the at least one control message at the second device.

18. The first device according to claim 17, wherein the further key is obtained by a Diffie-Hellman key exchange protocol.

19. A computer-readable medium in a first device for sending data to a second device over a network, the medium having stored thereon, computer-readable and computer-executable instructions which, when executed by a processor, cause the processor to perform actions comprising:
sending at least one control message to the second device along a control channel prior to establishing a data channel between the first device and the second device;
including some data from a data source in the at least one control message sent prior to establishing the data channel; and
sending remaining data from the data source to the second device along the data channel once the data channel has been established.

20. The computer-readable medium according to claim 19, further causing the processor to perform acts comprising:
encrypting the data included in the at least one control message with a temporary key;
encrypting key information identifying the temporary key with a further key known only to the first device and second device; and
sending the encrypted key information to the second device along the data channel, once the data channel has been established, for decrypting the data included in the at least one control message at the second device.
